(19) United States
(12) Patent Application Publication
(10) Pub. No.: US 2021/0018776 A1
(43) Pub. Date: Jan. 21, 2021

(54) DISPLAY PANEL AND DISPLAY DEVICE

(71) Applicant: HKC CORPORATION LIMITED, Shenzhen (CN)

(72) Inventor: Zhenli SONG, Shenzhen (CN)

(21) Appl. No.: 17/042,409

(22) PCT Filed: Dec. 19, 2018
(86) PCT No.: PCT/CN2018/122170

§ 371 Date: Sep. 28, 2020

(30) Foreign Application Priority Data
Dec. 5, 2018 (CN) 201811484755.8

(51) Int. Cl. G02F 1/1339; G02F 1/1343; G02F 1/1335; G02F 1/1337

(52) U.S. Cl. CPC G02F 1/1339; G02F 1/134309; G02F 1/1337; G02F 1/133512; G02F 1/133514

(57) ABSTRACT

A display panel and a display device are provided. The display panel includes a first substrate assembly, an electrode layer, a second substrate assembly and a signal layer. The electrode layer is attached to the first substrate assembly, and the second substrate assembly is adjacent to the electrode layer. The signal layer is attached to the second substrate assembly. The display panel includes a sealant abutted against the electrode layer and the signal layer, and a liquid crystal arranged between the electrode layer and the signal layer at a lateral surface of the sealant. The sealing member is arranged at a lateral surface of the sealant and seals the electrode layer and/or the signal layer. The present application aims at improving the sealing performance of ITO at the outer side of the sealant, preventing the electrode layer from being corroded and improving the product quality.

### CROSS REFERENCE TO RELATED APPLICATIONS

The present application is the National Stage of International Application No. PCT/CN2018/122170, filed on Dec. 19, 2018, which claims the benefit of Chinese patent application filed in the National Intellectual Property Administration on Dec. 5, 2018, with the application No. 201811484755.8 and title “Display panel and display device”, the entire contents of which are hereby incorporated by reference.

### TECHNICAL FIELD

The present application relates to the technical field of display, and in particular to a display panel and a display device using the display panel.

### BACKGROUND

A Liquid Crystal Display (LCD) includes a Color Filter (CF) substrate and an array substrate, and a liquid crystal layer sandwiched between the two substrates. After completing their respective technological processes, the two substrates are injected with liquid crystal in between through the ODF technology, and then assembling is finished through sealing. As the CF substrate and the array substrate are covered with an entire surface of ITO, the ITO which are on the outer side of the sealant is exposed to air, and vulnerable to contact with water vapor or cleaning agent during the application of the liquid crystal panel. In a turn-on state, ITO will generate potential difference with the outside. In addition to the water participation in the chemical reaction as the solvent as well as the reactant, the electrode is easy to be corroded. Even more seriously, ITO will be corroded from the periphery of Active Area into Active Area, resulting in the defect of the panel display and product quality.

### SUMMARY

The main purpose of the present application is to provide a display panel, aiming at improving the sealing performance of ITO at the outer side of the sealant, preventing the electrode layer from being corroded and improving the product quality.

In order to achieve the above object, the display panel provided by the present application includes a first substrate assembly, an electrode layer, a second substrate assembly and a signal layer. The electrode layer is attached to a surface of the first substrate assembly, and the second substrate assembly is arranged adjacent to the electrode layer, and the signal layer is attached to a surface of the second substrate assembly facing the electrode layer. The display panel further includes:

a liquid crystal arranged between the electrode layer and the signal layer;

a sealant, two ends of which are respectively abutted against a surface of the electrode layer and a surface of the signal layer, and the liquid crystal is positioned at a side of the sealant; and

a sealing member arranged on a side of the sealant away from the liquid crystal and configured to seal the electrode layer and/or the signal layer.

Optionally, the display panel includes an active display area and an inactive display area adjacent to the active display area;

the electrode layer and/or the signal layer is extended from the active display area to the inactive display area, and is extended out of a lateral surface of the sealant away from the liquid crystal;

the sealing member is configured to seal the portion of the electrode layer and/or the signal layer extended out of the lateral surface of the sealant away from the liquid crystal.

Optionally, the electrode layer includes a first surface, a second surface and a first lateral surface. The first surface and the second surface are oppositely arranged, and the first lateral surface are connected with the first surface and the second surface.

The first surface is attached to the first substrate assembly. The sealant is abutted against to the second surface, allowing the second surface to form an active display area and an inactive display area.

The sealing member is configured to attach to the first lateral surface and the inactive display area, and sealant a joint of the electrode layer, the first substrate assembly and the sealant.

Optionally, the signal layer includes a third surface, a fourth surface and a second lateral surface. The third surface and the fourth surface are oppositely arranged, and the second lateral surface is connecting the third surface and the fourth surface.

The third surface is attached to the second substrate assembly, the sealant is abutted against to the fourth surface, allowing the fourth surface to form an abutting area and a display area.

The sealing member is configured to attach to the second lateral surface and the abutting area, and sealant a joint of the signal layer, the second substrate assembly and the sealant.

Optionally, the display panel further includes an active display area and an inactive display area adjacent to the active display area. The electrode layer and/or the signal layer is extended from the active display area to the inactive display area, and are aligned with a lateral surface of the sealant away from the liquid crystal.

The sealing member is configured to sealant the portion of the electrode layer and/or the signal layer aligned with a lateral surface of the sealant away from the liquid crystal.

Optionally, the electrode layer includes a first surface, a second surface and a first lateral surface. The first surface and the second surface are oppositely arranged, and the first lateral surface is connected with the first surface and the second surface.

The first surface is attached to the first substrate assembly. The second surface is arranged adjacent to the sealant, and the sealing member is configured to attach to the first lateral surface and seal a joint of the electrode layer, the first substrate assembly and the sealant.

Optionally, the signal layer includes a third surface, a fourth surface and a second lateral surface, the third surface and the fourth surface are oppositely arranged, and the second lateral surface is connecting the third surface and the fourth surface.

The third surface is attached to the second substrate assembly. The sealant is abuttedly connected to the fourth surface. The sealing member is configured to attach to the second lateral surface and seal a joint of the signal layer, the second substrate assembly and the sealant.

Optionally, the sealing member includes a first sealing portion and a second sealing portion. The first sealing portion is fixedly connected with the electrode layer, and the second sealing portion is fixedly connected with the signal layer.

Optionally, the first sealing portion and the second sealing portion are both waterproof members.

Optionally, the first sealing portion and the second sealing portion are both hydrophobic films.

Optionally, one of the first sealing portion and the second sealing portion is a waterproof member, and the other one of the first sealing portion and the second sealing portion is a hydrophobic film.

Optionally, the thickness of the hydrophobic film is 0.1 to 5. m.

Optionally, the first substrate assembly includes a color filter layer substrate, a light shielding layer attached to a surface of the color filter layer substrate, and a first alignment film. The electrode layer is attached to a surface of the light shielding layer away from the color filter layer substrate; and the first alignment film is attached to a surface of the electrode layer away from the light shielding layer.

Optionally, the second substrate assembly includes an array substrate, a signal layer attached to a surface of the array substrate, and a second alignment film. The array substrate is further arranged with an array electrode layer positioned on a same surface of the array substrate with the signal layer. The second alignment film is positioned on a surface of the signal layer and of the array electrode layer away from the array substrate.

The present application also provides a display panel including a first substrate assembly, an electrode layer attached to a surface of the first substrate assembly, a second substrate assembly arranged adjacent to the electrode layer, and a signal layer attached to a surface of the second substrate assembly facing the electrode layer. The display panel further includes: a liquid crystal arranged between the electrode layer and the signal layer. In which, the display panel includes:

a sealant, two ends of which are respectively abutted against a surface of the electrode layer and a surface of the signal layer, and the liquid crystal is positioned at a side of the sealant; and

a sealing member arranged on a side of the sealant away from the liquid crystal and configured to seal the electrode layer and/or the signal layer;

the electrode layer includes a first surface, a second surface and a first lateral surface connecting the first surface and the second surface, the first surface being attached to the first substrate assembly, the sealant being abutted against to the second surface, the sealing member being configured to attach to the first lateral surface and the second surface, and seal a joint of the signal layer, the first substrate assembly and the sealant; in which

the signal layer includes a third surface, a fourth surface and a second lateral surface connecting the third surface and the fourth surface, the third surface being attached to the second substrate assembly, the sealant being abutted against to the fourth surface, the sealing member being configured to attach to the second lateral surface and the fourth surface, and seal a joint of the signal layer, the second substrate assembly and the sealant.

The present application further provides a display device including a first substrate assembly, an electrode layer, a second substrate assembly and a signal layer. The electrode layer is attached to a surface of the first substrate assembly, and the second substrate assembly is arranged adjacent to the electrode layer, and the signal layer is attached to a surface of the second substrate assembly facing the electrode layer. The display panel further includes:

a liquid crystal arranged between the electrode layer and the signal layer;

a sealant, two ends of which are respectively abutted against a surface of the electrode layer and a surface of the signal layer, and the liquid crystal is positioned at a side of the sealant; and

a sealing member arranged on a side of the sealant away from the liquid crystal and configured to seal the electrode layer and/or the signal layer.

According to the technical solution of the present application, the sealant is abutted against a surface of the electrode layer and/or the signal layer, and the sealing member is arranged on the side of the sealant away from the liquid crystal. It is sealed that the portion which electrode layer and/or the signal layer is exposed out of the sealant, so that the electrode layer and/or the signal layer are isolated from the external environment during the using process of the liquid crystal panel. External water vapor or any cleaning agent may not contact with the electrode layer and/or the signal layer, thus preventing the corrosion of the electrode layer caused by the water participating as a solvent or a reactant in a chemical reaction. Since the electrode layer and/or the signal layer free of contacting with water vapor or the like, no conductive medium is available. Even when a potential difference is generated by the electrode and the external environment, the electrode layer and/or the signal layer will not react with external water vapor, thus preventing corrosion of the electrode layer. As such, the sealing performance can be improved of the electrode layer outside the sealant according to the technical solution of the present application, preventing the electrode layer from being corroded and improving the product quality.

### BRIEF DESCRIPTION OF THE DRAWINGS

In order to explain the embodiment of the present application or the technical solution of the prior art more clearly, the following will briefly introduce the drawings necessary in the description of the embodiments or the prior art. Obviously, the drawings in the following description are only some embodiments of the present application. For those ordinary skill in the art, other drawings can be obtained according to the structure shown in these drawings without any creative effort.

FIG. 1 is a schematic structural diagram of a display panel according to some embodiments of the present application.

FIG. 2 is a schematic structural diagram a display panel according to some different embodiments of the present application.

FIG. 3 is a schematic structural diagram a display panel according to other different embodiments of the present application.

FIG. 4 is a schematic structural diagram a display panel according to other different embodiments of the present application.

The implementation, functional characteristics and advantages of the present application will be further described with reference to the attached drawings in combination with embodiments.

### DETAILED DESCRIPTION OF THE EMBODIMENTS

As following, the technical solution in the embodiments of the present application will be described clearly and completely with reference to the drawings in the embodiment of the present application. Obviously, the described embodiment is only a part of the embodiment of the present application, not all of the embodiments. Based on the embodiments in the present application, all other embodiments perceived by those ordinary skills in the art without creative effort should be fallen within the protection scope of the present application.

It should be noted that all directional indicators (such as upper, lower, left, right, front, rear, etc.) in the embodiment of the present application are only used to explain the relative positional relationship, movement, etc. between various components under a certain specific posture (as shown in the drawings). If the specific posture changes, the directional indicator will also change accordingly.

In addition, the descriptions related to “first”, “second” and the like in the present application are for descriptive purposes only and cannot be understood as indicating or implying its relative importance or implicitly indicating a number of technical features indicated. Thus, features defining “first” and “second” may explicitly or implicitly include at least one of the features. In addition, the technical solutions between the various embodiments can be combined with each other, but it must be based on the realization by ordinary skilled in the art. When the combination of technical solutions is contradictory or cannot be realized, it should be considered that the combination of such technical solutions does not exist and is not within the scope of protection claimed in the present application.

The present application provides a display panel 100.

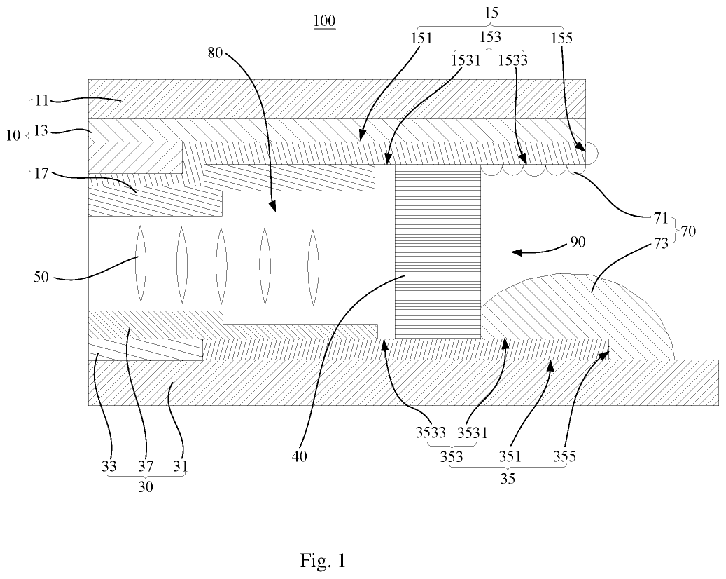

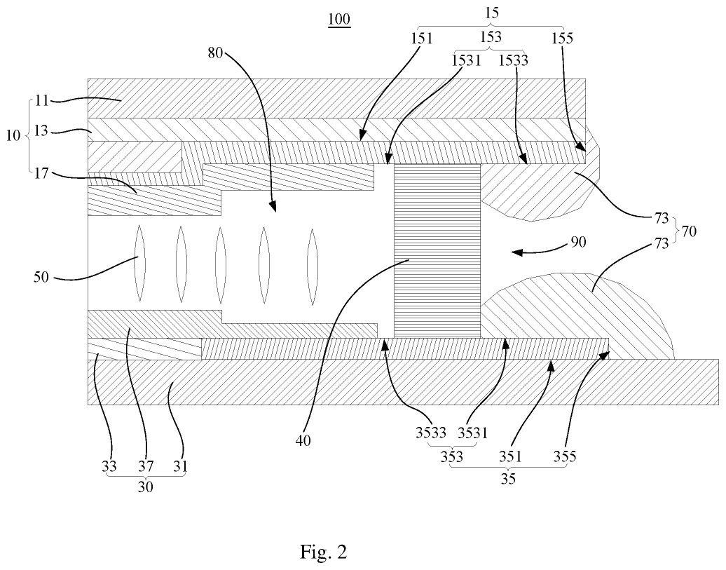

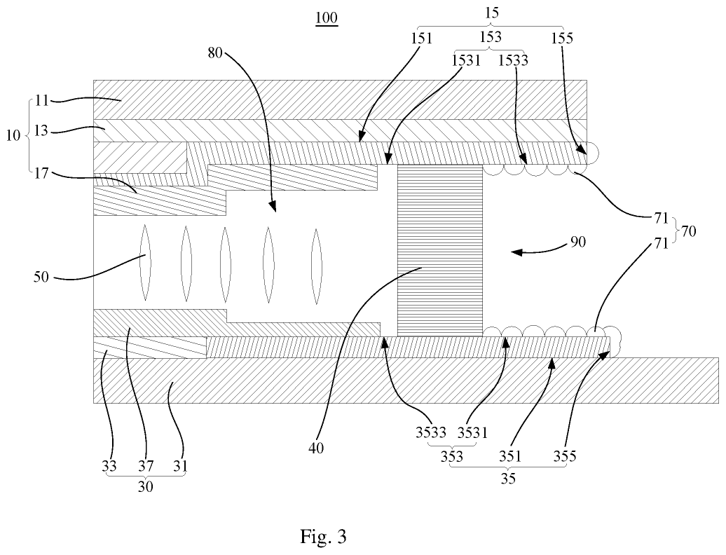

Referring to FIGS. 1 to 4, according to the technical solution of the present application, the display panel 100 includes a first substrate assembly 10, an electrode layer 15 attached to a surface of the first substrate assembly 10, a second substrate assembly 30 arranged adjacent to the electrode layer 15, and a signal layer 35 attached to a surface of the second substrate assembly 30 facing the electrode layer 15. The display panel 100 further includes: a liquid crystal 50 arranged between the electrode layer 15 and the signal layer 35. The display panel 100 further includes as follows.

A sealant 40, two ends of the sealant 40 are respectively abutted against a surface of the electrode layer 15 and a surface of the signal layer 35, and the liquid crystal 50 is positioned at one side of the sealant 40.

A sealing member 70, which is arranged on the side of the sealant 40 away from the liquid crystal 50 and is sealing the electrode layer 15 and/or the signal layer 35.

According to the technical solution of the present application, the sealant 40 is abutted against a surface of the electrode layer 15 and/or the signal layer 35, and the sealing member 70 is arranged on the side of the sealant 40 away from the liquid crystal 50. It is sealed that the portion which electrode layer 15 and/or the signal layer 35 is exposed out of the sealant 40, so that the electrode layer 15 and/or the signal layer 35 are isolated from the external environment during the using process of the liquid crystal 50 panel. External water vapor or any cleaning agent may not contact with the electrode layer 15 and/or the signal layer 35, thus preventing the corrosion of the electrode layer 15 caused by the water participating as a solvent or a reactant in a chemical reaction. Since the electrode layer 15 and/or the signal layer 35 free of contacting with water vapor or the like, no conductive medium is available. Even when a potential difference is generated by the electrode and the external environment, the electrode layer 15 and/or the signal layer 35 will not react with external water vapor, thus preventing corrosion of the electrode layer 15. As such, the sealing performance can be improved of the electrode layer 15 outside the sealant 40 according to the technical solution of the present application, preventing the electrode layer 15 from being corroded and improving the product quality.

In some embodiments of the present application, the first substrate assembly 10 includes a color filter layer substrate 11, a light shielding layer 13 (black matrix layer) attached to a surface of the color filter layer substrate 11, and a first alignment film 17. In which the electrode layer 15 is attached to the surface of the light shielding layer 13 away from the color filter layer substrate 11, and the first alignment film 17 is attached to the surface of the electrode layer 15 away from the light shielding layer 13; The second substrate assembly 30 includes an array substrate 31, a signal layer 35 attached to the surface of the array substrate 31, and a second alignment film 37. The array substrate 31 is also provided with an array electrode layer 33, which is positioned on the same surface of the array substrate 31 as the signal layer 35. The second alignment film 37 is positioned on the surface of the signal layer 35 and the array electrode layer 33 away from the array substrate 31. The electrode layer 15 is attached to the surface of the light shielding layer 13 away from the color filter layer substrate 11, and the first alignment film 17 is attached to the surface of the electrode layer 15 away from the light shielding layer 13. The second substrate assembly 30 includes an array substrate 31, a signal layer 35 attached to the surface of the array substrate 31, and a second alignment film 37. The array substrate 31 is also provided with an array electrode layer 33, which is positioned on the same surface of the array substrate 31, together with the signal layer 35. The second alignment film 37 is positioned on the surfaces of the signal layer 35 and the array electrode layer 33 away from the array substrate 31. Both ends of the sealant 40 respectively abut against the electrode layer 15 and the signal layer 35, so that a cell gap is formed between the color filter layer substrate 11 and the array substrate 31, to accommodate the liquid crystal 50. It can be understood that the sealing member 70 can seal the electrode layer 15 and/or the signal layer 35 on the side of the sealant 40 away from the liquid crystal 50. A reserved position for electric signal transmission may also be considered during sealing to facilitate signal transmission, since electric signals may be necessary to transmit from the electrode layer 15.

Referring to FIGS. 1 to 3, in some embodiments of the present application, the display panel 100 further includes an active display area 80 and an inactive display area 90 adjacent to the active display area 80. The electrode layer 15 and/or the signal layer 35 is extended from the active display area 80 to the inactive display area 90 and extended out of the lateral surface of the sealant 40 away from the liquid crystal 50. The sealing member 70 may seal the portion of the electrode layer 15 and/or the signal layer 35 which are extended out of the lateral surface of the sealant 40 away from the liquid crystal 50. In some embodiments, the transmission of electrical signals and data signals of the display panel 100 tends to be convenient by the provision that the electrode layer 15 or the signal layer 35 extends out of the lateral surface of the sealant 40 away from the liquid crystal 50. Furthermore, the cutting of the display panel 100 can be implemented without precise alignment, facilitating its production. The sealing member 70 is provided since the electrode layer 15 and the signal layer 35 are easy to contact and react with the water vapor in the air to result in corrosion. The sealing member 70 is to seal the portion of the electrode layer 15 and the signal layer 35 which is extended out of the lateral surface of the sealant 40 away from the liquid crystal 50, to prevent the contact between the electrode layer 15 and the signal layer 35 and the water vapor and the further corrosion.

In some embodiments of the present application, the electrode layer 15 includes a first surface 151, a second surface 153, and a first lateral surface 155 connecting the first surface 151 and the second surface 153. The first surface 151 is attached to the first substrate assembly 10, the sealant 40 is abutted against to the second surface 153, to allow the second lateral surface into the active display area 1531 and the inactive display area 1533. The sealing member 70 is configured to attach to the first lateral surface 155 and the inactive display area 1533, and seal the joint between the electrode layer 15 and the first substrate assembly 10 and the sealant 40. The first lateral surface 155 of the electrode layer 15 and the inactive display area 1533 are exposed to air. In order to prevent the electrode layer 15 from chemically reacting with water vapor, the first lateral surface 155 of the electrode layer 15 and the inactive display area 1533 are sealed by the sealing member 70, so that contact and corrosion of the electrode layer 15 with water vapor can be stopped. Water vapor can further be avoided of entering the space where the liquid crystal 50 is positioned, ensuring the normal operation of the display panel 100.

In some embodiments of the present application, the signal layer 35 includes a third surface 351, a fourth surface 353, and a second lateral surface 355 connecting the third surface 351 and the fourth surface 353. The third surface 351 is attached to the second substrate assembly 30, the sealant 40 is abutted against to the fourth surface 353, to allow the fourth lateral surface into the active display area 3531 and the inactive display area 3533. The sealing member 70 is configured to attach to the second lateral surface 355 and the abutting area 3531, and sealant the joint between the electrode layer 35 and the second substrate assembly 30 and the sealant 40. The third lateral surface 355 of the signal layer 35 and the abutting area 3531 are exposed to air. In order to prevent the electrode layer 35 from chemically reacting with water vapor, the second lateral surface 355 of the electrode layer 35 and the abutting area 3531 are sealed by the sealing member 70, so that contact and corrosion of the electrode layer 35 with water vapor can be stopped. Water vapor can further be avoided of entering the space where the liquid crystal 50 is positioned, ensuring the normal operation of the display panel 100.

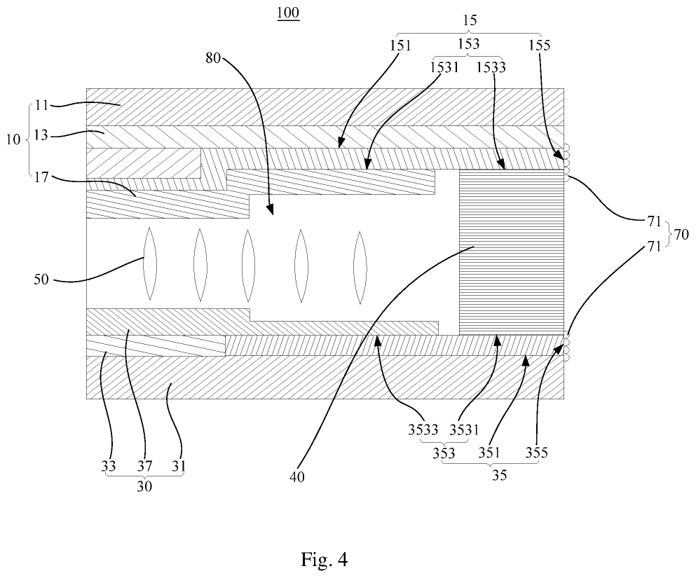

Referring to FIG. 4, in some embodiments of the present application, the display panel 100 further includes an active display area 80 and an inactive display area 90 adjacent to the active display area 80. The electrode layer 15 and/or the signal layer 35 is extended from the active display area 80 to the inactive display area 90 and align with the lateral surface of the sealant 40 away from the liquid crystal 50. The sealing member 70 may seal the portion of the electrode layer 15 and/or the signal layer 35 which are aligned with the lateral surface of the sealant 40 away from the liquid crystal 50. In some embodiments, the electrode layer 15 and/or the signal layer 35 are aligned with the lateral surface of the sealant 40 away from the liquid crystal 50, so that the size can be made smaller of the display panel 100, thereby facilitating the installation of the display panel 100 on a display device with a required size. The sealing member 70 is provided since the electrode layer 15 and the signal layer 35 are easy to contact and react with the water vapor in the air to result in corrosion. The sealing member 70 is to seal the portion of the electrode layer 15 and the signal layer 35 which is aligned with the lateral surface of the sealant 40 away from the liquid crystal 50, to prevent the contact between the electrode layer 15 and the signal layer 35 and the water vapor and the further corrosion.

In some embodiments of the present application, the electrode layer 15 includes a first surface 151, a second surface 153, and a first side 155 connecting the first surface 151 and the second surface 153. The first surface 151 is attached to the first substrate assembly 10, and the second surface 153 is arranged adjacent to the sealant 40. The sealing member 70 is attached to the first side 155, and seals the joint of the electrode layer 15 and the first substrate assembly 10 and the sealant 40.

In some embodiments of the present application, the signal layer 35 includes a third surface 351, a fourth surface 353, and a second lateral surface 355 connecting the third surface 351 and the fourth surface 353. The third surface 351 is attached to the second substrate assembly 30, the sealant 40 is abutted against to the fourth surface 353. The sealing member 70 is configured to attach to the second lateral surface 355 and the abutting area 3531, and seal the joint between the electrode layer 35 and the second substrate assembly 30 and the sealant 40. The first side 155 and the second side 355 can be prevented from contacting with water vapor in the external environment, by fitting the sealing member 70 on the first lateral surface 155 and the second lateral surface 355, thereby preventing the electrode layer 15 and the signal layer 35 from corrosion.

Referring to FIGS. 1 to 4, in some embodiments of the present application, the sealing member 70 includes a first sealing portion 71 and a second sealing portion 73. The first sealing portion 71 is fixedly connected to the electrode layer 15 and the second sealing portion 73 is fixedly connected to the signal layer 35. The sealing effect can be improved regarding to the electrode layer 15 and the signal layer 35, by setting the first sealing portion 71 and the second sealing portion 73 to seal the electrode layer 15 and the signal layer 35 respectively. According to different waterproof requirements of the electrode layer 15 and the signal layer 35, sealing parts provides different waterproof levels, to improve the sealing adaptivity of the sealing member 70.

In some embodiments of the present application, the first sealing portion 71 and the second sealing portion 73 are both waterproof members. The waterproof member can be waterproof glue. Specifically, the waterproof glue can be tuffy glue, which is a resin glue specially used in the electronic industry, and is often volatilea and highly toxic in a liquid form in color of blue. it becomes thin, light blue after applied and curing, and easy to tear off. The Tuffy glue used for general modules is mainly used on ITO stage circuits to protect IC and its related microcircuits, providing a good water proof for the electrode layer 15 and the signal layer 35.

In some embodiments of the present application, the first sealing portion 71 and the second sealing portion 73 are both hydrophobic films. The hydrophobic film can be formed by sputtering fluorine ions onto the surface of the electrode layer 15. The sputtering technology bombards the target surface with ions, is the knocking out of atoms of the target. Atoms generated by sputtering are deposited on the surface of the substrate to form a film, which is called sputtering coating. Generally, gas ionization is generated by gas discharge. In which the positive ions bombard the cathode target body at a high speed under the action of an electric field, and atoms or molecules of the cathode target body is blown out, and fly to the surface of a substrate to deposit a thin film. The thickness of the hydrophobic film can be 0.1 μm to 5 μm. As the signal layer 35 and the electrode layer 15 still need to transmit data signals, the hydrophobic film with a thickness greater than 5 μm is easy to cause instability of signal transmission. However, a hydrophobic film with a thickness of less than 0.1 μm may not block fine water vapor. When the thickness of the hydrophobic film is between 0.1 μm and 5 μm, the transmission of data signals can be facilitated, and the hydrophobic film can prevent corrosion of the electrode layer 15 and the signal layer 35. It can be understood that the thickness of the hydrophobic membrane can also be 0.3 μm, 0.5 μm, 0.7 μm, 0.9 μm, 1 μm, 1.3 μm, 1.5 μm, 1.8 μm, 2 μm, 2.5 μm, 2.7 μm, 3 μm, 4 μm, 4.5 μm, which can ensure good hydrophobicity of the hydrophobic membrane and facilitate signal transmission. Optionally, the thickness of the hydrophobic membrane is 0.3 μm-1 μm, which can ensure good hydrophobicity of the hydrophobic membrane and facilitate signal transmission.

In some embodiments of the present application, one of the first sealing portion 71 and the second sealing portion 73 is a waterproof member, and the other of the first sealing portion 71 and the second sealing portion 73 is a hydrophobic film. It can be understood that in order to carry out adaptive design according to different signal transmission, one of the first sealing portion 71 and the second sealing portion 73 may be provided as a waterproof member and the other as a hydrophobic film, respectively. In some embodiments, the first sealing portion 71 is provided as a hydrophobic film and the second sealing portion 73 is provided as a waterproof member. Since the electrode layer 15 needs to be power traced, the transmission effect of electrical signals can be improved by sealing it with a hydrophobic film.

The present application further provides a display device, which includes a display panel 100 including a first substrate assembly 10, an electrode layer 15 attached to a surface of the first substrate assembly 10, a second substrate assembly 30 arranged adjacent to the electrode layer 15, and a signal layer 35 attached to a surface of the second substrate assembly 30 facing the electrode layer 15. The display panel 100 further includes: a liquid crystal 50 arranged between the electrode layer 15 and the signal layer 35. The display panel 100 further includes as follows.

A sealant 40, two ends of the sealant 40 are respectively abutted against a surface of the electrode layer 15 and a surface of the signal layer 35, and the liquid crystal 50 is positioned at one side of the sealant 40.

A sealing member 70, which is arranged on the side of the sealant 40 away from the liquid crystal 50 and is sealing the electrode layer 15 and/or the signal layer 35. Since the display device adopts all the technical solutions of the above embodiments, it also has all the beneficial effects brought by the technical solutions of the aforementioned embodiments, and will not be repeated herein.

This is only some embodiments of the present application and is not intended to limit the scope of the present application. Any equivalent structural change made under the concept of the present application using the contents of the present application specification and drawings, or directly/indirectly applied in other related technical fields, shall be included in the protection scope of the present application.

1. A display panel, comprising: a first substrate assembly, an electrode layer, a second substrate assembly, and a signal layer, the electrode layer being attached to a surface of the first substrate assembly, the second substrate assembly being arranged adjacent to the electrode layer, the signal layer being attached to a surface of the second substrate assembly facing the electrode layer; wherein the display panel further comprises:
a liquid crystal arranged between the electrode layer and the signal layer;
a sealant, two ends of the sealant being respectively abutted against a surface of the electrode layer and a surface of the signal layer, and the liquid crystal being positioned at a side of the sealant; and
a sealing member arranged on a side of the sealant away from the liquid crystal and configured to seal the electrode layer and/or the signal layer.

2. The display panel of claim 1, wherein
the display panel comprises an active display area and an inactive display area adjacent to the active display area;
the electrode layer and/or the signal layer is extended from the active display area to the inactive display area, and is extended out of a lateral surface of the sealant away from the liquid crystal;
the sealing member is configured to seal the portion of the electrode layer and/or the signal layer extended out of the lateral surface of the sealant away from the liquid crystal.

3. The display panel of claim 2, wherein
the sealing member comprises a first sealing portion and a second sealing portion,
the first sealing portion is fixedly connected with the electrode layer, and the second sealing portion is fixedly connected with the signal layer.

4. The display panel of claim 3, wherein
the electrode layer comprises a first surface, a second surface and a first lateral surface,
the first surface and the second surface are oppositely arranged, the first lateral surface is connected with the first surface and the second surface; wherein
the first surface is attached to the first substrate assembly, the sealant is abutted against to the second surface and allows the second surface to form an active display area and an inactive display area;
the sealing member is configured to attach to the first lateral surface and the inactive display area, and seal a joint of the electrode layer, the first substrate assembly, and the sealant.

5. The display panel of claim 2, wherein
the signal layer comprises a third surface, a fourth surface and a second lateral surface,
the third surface and the fourth surface are oppositely arranged, the second lateral surface connects the third surface with the fourth surface,
the third surface is attached to the second substrate assembly, the sealant is abutted against to the fourth surface and allows the fourth surface to form an abutting area and a display area; wherein
the sealing member is configured to attach to the second lateral surface and the abutting area, and seal a joint of the signal layer, the second substrate assembly, and the sealant.

6. The display panel of claim 1, wherein
the display panel further comprises an active display area and an inactive display area adjacent to the active display area; wherein
the electrode layer and/or the signal layer is extended from the active display area to the inactive display area, and are aligned with a lateral surface of the sealant away from the liquid crystal;
the sealing member is configured to seal the portion of the electrode layer and/or the signal layer aligned with a lateral surface of the sealant away from the liquid crystal.

7. The display panel of claim 6, wherein
the sealing member comprises a first sealing portion and a second sealing portion,
the first sealing portion is fixedly connected with the electrode layer, and the second sealing portion is fixedly connected with the signal layer.

8. The display panel of claim 7, wherein
the electrode layer comprises a first surface, a second surface and a first lateral surface,
the first surface and the second surface are oppositely arranged, the first lateral surface is connected with the first surface and the second surface; wherein
the first surface is attached to the first substrate assembly; the second surface is arranged adjacent to the sealant, and the sealing member is configured to attach to the first lateral surface and seal a joint of the electrode layer, the first substrate assembly and the sealant.

9. The display panel of claim 8, wherein the signal layer comprises a third surface, a fourth surface and a second lateral surface,
the third surface and the fourth surface are oppositely arranged, the second lateral surface connects the third surface with the fourth surface; wherein
the third surface is attached to the second substrate assembly; the sealant is abutted against the fourth surface; and
the sealing member is configured to attach to the second lateral surface and seal a joint of the signal layer, the second substrate assembly and the sealant.

10. The display panel of claim 1, wherein
the sealing member comprises a first sealing portion and a second sealing portion,
the first sealing portion is fixedly connected with the electrode layer, the second sealing portion is fixedly connected with the signal layer.

11. The display panel of claim 10, wherein the first sealing portion and the second sealing portion are both waterproof members.

12. The display panel of claim 10, wherein the first sealing portion and the second sealing portion are both hydrophobic films.

13. The display panel of claim 10, wherein
one of the first sealing portion and the second sealing portion is a waterproof member, and the other one of the first sealing portion and the second sealing portion is a hydrophobic film.

14. The display panel according to claim 13, wherein a thickness of the hydrophobic film ranges from 0.1 micrometer to 5 micrometers.

15. The display panel of claim 1, wherein
the first substrate assembly comprises:
a color filter layer substrate;
a light shielding layer attached to a surface of the color filter layer substrate; and
a first alignment film; wherein
the electrode layer is attached to a surface of the light shielding layer away from the color filter layer substrate; and
the first alignment film is attached to a surface of the electrode layer away from the light shielding layer.

16. The display panel of claim 1, wherein
the second substrate assembly comprises an array substrate, a signal layer attached to a surface of the array substrate, and a second alignment film; wherein
the array substrate is further arranged with an array electrode layer positioned on a same surface of the array substrate with the signal layer; and
the second alignment film is arranged on a surface of the signal layer away from the array substrate and a surface of the array electrode layer away from the array substrate.

17. A display panel, comprising a first substrate assembly; an electrode layer attached to a surface of the first substrate assembly; a second substrate assembly arranged adjacent to the electrode layer; and a signal layer attached to a surface of the second substrate assembly facing the electrode layer; wherein the display panel further comprises a liquid crystal arranged between the electrode layer and the signal layer, wherein the display panel comprises:
a sealant, two ends of the sealant are respectively abutted against a surface of the electrode layer and a surface of the signal layer, and the liquid crystal is positioned at one side of the sealant; and
a sealing member arranged on a side of the sealant away from the liquid crystal and configured to seal the electrode layer and/or the signal layer;
wherein the electrode layer comprises: a first surface, a second surface and a first lateral surface connecting the first surface and the second surface, the first surface being attached to the first substrate assembly, the sealant being abutted against to the second surface, the sealing member being configured to attach to the first lateral surface and the second surface, and seal a joint of the signal layer, the first substrate assembly and the sealant;
wherein the signal layer comprises a third surface, a fourth surface and a second lateral surface connecting the third surface and the fourth surface, the third surface being attached to the second substrate assembly, the sealant being abutted against to the fourth surface, the sealing member being configured to attach to the second lateral surface and the fourth surface, and seal a joint of the signal layer, the second substrate assembly and the sealant.

18. A display device, comprising a display panel, the display panel comprising: a first substrate assembly, an electrode layer, a second substrate assembly, and a signal layer, the electrode layer being attached to a surface of the first substrate assembly, the second substrate assembly being arranged adjacent to the electrode layer, the signal layer being attached to a surface of the second substrate assembly facing the electrode layer; wherein the display panel further comprises:
a liquid crystal arranged between the electrode layer and the signal layer;
a sealant, two ends of the sealant being respectively abutted against a surface of the electrode layer and a surface of the signal layer, and the liquid crystal being positioned at a side of the sealant; and
a sealing member arranged on a side of the sealant away from the liquid crystal and configured to seal the electrode layer and/or the signal layer.
